(19) United States
(12) Patent Application Publication
(10) Pub. No.: US 2013/0337303 A1
(43) Pub. Date: Dec. 19, 2013

(54) INCREASING THE ENERGY DENSITY OF BATTERY CELLS FOR PORTABLE ELECTRONIC DEVICES

(71) Applicants: Ramesh C. Bhardwaj, Fremont, CA (US); Taisup Hwang, Santa Clara, CA (US)

(72) Inventors: Ramesh C. Bhardwaj, Fremont, CA (US); Taisup Hwang, Santa Clara, CA (US)

(73) Assignee: APPLE INC., Cupertino, CA (US)

(21) Appl. No.: 13/526,413

(22) Filed: Jun. 18, 2012

(51) Int. Cl. H01M 10/36; H01M 4/04; B05D 5/12; H01M 10/04; B65H 18/00; H01M 4/02; H01M 4/66

(52) U.S. Cl. 429/94; 429/209; 429/245; 29/623.2; 242/520; 427/58

(57) ABSTRACT

The disclosed embodiments relate to the manufacture of a battery cell. The battery cell includes a set of layers including a cathode and an anode. The cathode includes a cathode substrate with a thickness in the range of 8-10 microns and a cathode active material. The anode includes an anode substrate with a thickness in the range of 4-6 microns and an anode active material. The cathode active material is coated on the cathode substrate at a rate of 2 mm/min to 3 mm/min, and the anode active material is coated on the anode substrate at a rate of 2 mm/min to 3.8 mm/min. Such substrate thicknesses and coating speeds may increase the energy density of the battery cell over that of a conventional battery cell with thicker cathode and anode substrates while avoiding manufacturing defects associated with the use of thinner substrates in battery cells.

### BACKGROUND

1. Field

The disclosed embodiments relate to batteries for portable electronic devices. More specifically, the disclosed embodiments relate to techniques for increasing the energy density of battery cells for portable electronic devices.

2. Related Art

Rechargeable batteries are presently used to provide power to a wide variety of portable electronic devices, including laptop computers, tablet computers, mobile phones, personal digital assistants (PDAs), digital music players and cordless power tools. The most commonly used type of rechargeable battery is a lithium battery, which can include a lithium-ion or a lithium-polymer battery.

Lithium-polymer batteries often include cells that are packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device. Consequently, the use of portable electronic devices may be facilitated by improvements related to the packaging efficiency, capacity, form factor, design, and/or manufacturing of battery packs containing lithium-polymer battery cells.

### SUMMARY

The disclosed embodiments relate to the manufacture of a battery cell. The battery cell includes a set of layers including a cathode and an anode. The cathode includes a cathode substrate with a thickness in the range of 8-10 microns and a cathode active material. The anode includes an anode substrate with a thickness in the range of 4-6 microns and an anode active material. The cathode active material is coated on the cathode substrate at a rate of 2 mm/min to 3 mm/min, and the anode active material is coated on the anode substrate at a rate of 2 mm/min to 3.8 mm/min. Such substrate thicknesses and coating speeds may increase the energy density and/or charge current of the battery cell over that of a conventional battery cell with thicker cathode and anode substrates without producing manufacturing defects associated with the use of thinner cathode and anode substrates in battery cells and/or reducing the cycle life of the battery cell.

In some embodiments, the set of layers in the battery cell also includes a separator. During manufacture of the battery cell, the cathode, the anode, and the separator may be wound to create a jelly roll. Alternatively, the layers may be used to form other types of battery cell structures, such as bi-cell structures.

In some embodiments, the battery cell also includes a pouch enclosing the jelly roll, wherein the pouch is flexible. For example, the battery cell may be formed by placing the cathode, anode, and separator layers into the pouch, filling the pouch with electrolyte, and forming side and terrace seals along the edges of the pouch.

In some embodiments, the anode substrate includes copper foil.

In some embodiments, the cathode substrate includes aluminum foil.

### BRIEF DESCRIPTION OF THE FIGURES

FIG. 1 shows the placement of a battery in a computer system in accordance with the disclosed embodiments.

FIG. 2 shows a battery cell in accordance with the disclosed embodiments.

FIG. 3 shows an exemplary plot in accordance with the disclosed embodiments.

FIG. 4 shows an exemplary plot in accordance with the disclosed embodiments.

FIG. 5 shows an exemplary plot in accordance with the disclosed embodiments.

FIG. 6 shows an exemplary plot in accordance with the disclosed embodiments.

FIG. 7 shows a flowchart illustrating the process of manufacturing a battery cell in accordance with the disclosed embodiments.

FIG. 8 shows a portable electronic device in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

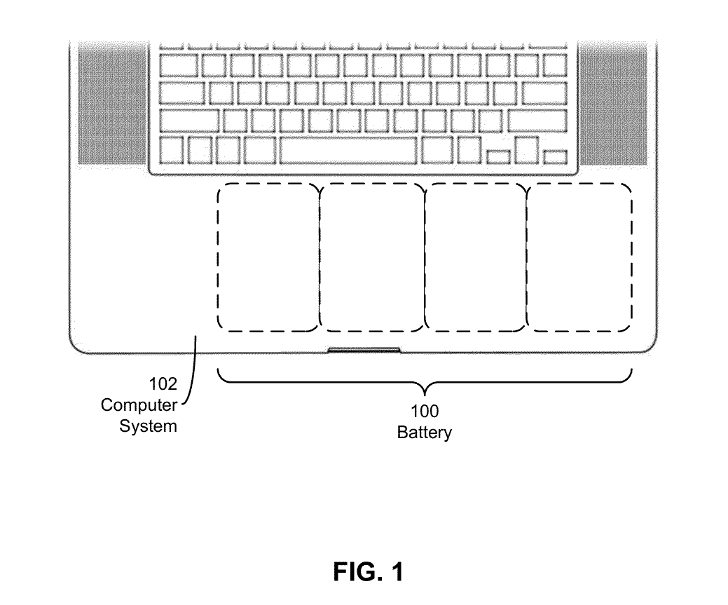

FIG. 1 shows the placement of a battery 100 in a computer system 102 in accordance with an embodiment. Computer system 102 may correspond to a laptop computer, personal digital assistant (PDA), portable media player, mobile phone, digital camera, tablet computer, and/or other portable electronic device. Battery 100 may correspond to a lithium-polymer battery and/or other type of power source for computer system 102. For example, battery 100 may include one or more lithium-polymer battery cells packaged in flexible pouches. The battery cells may then be connected in series and/or in parallel and used to power computer system 102.

In one or more embodiments, battery 100 is designed to accommodate the space constraints of computer system 102. For example, battery 100 may include battery cells of different sizes and thicknesses that are placed side-by-side, top-to-bottom, and/or stacked within computer system 102 to fill up the free space within computer system 102. The use of space within computer system 102 may additionally be optimized by omitting a separate enclosure for battery 100. For example, battery 100 may include non-removable pouches of lithium-polymer cells encased directly within the enclosure for computer system 102. As a result, the cells of battery 100 may be larger than the cells of a comparable removable battery, which in turn may provide increased battery capacity and weight savings over the removable battery.

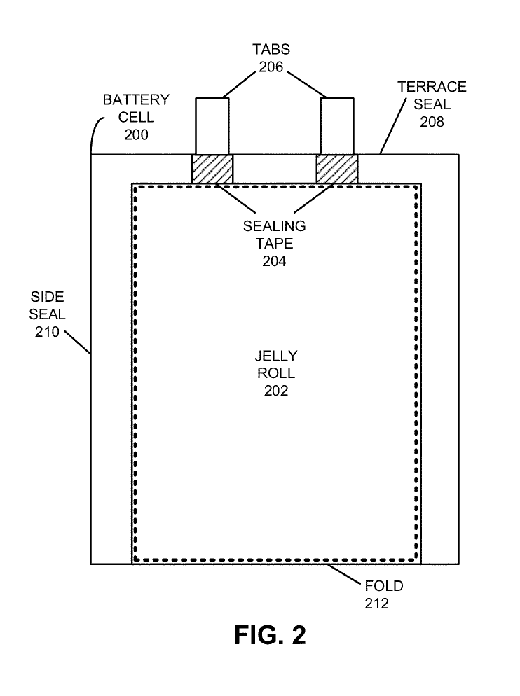

To further facilitate use of computer system 102 with battery 100, battery 100 may be manufactured with a higher proportion of cathode and anode active material to cathode and anode substrate than conventional lithium-polymer batteries. In turn, battery 100 may have a higher energy density and/or charge current than those of conventional lithium-polymer batteries. Increasing energy density and/or charge currents in lithium-polymer batteries is discussed in further detail below with respect to FIGS. 2-6.

FIG. 2 shows a battery cell 200 in accordance with an embodiment. Battery cell 200 may correspond to a lithium-polymer cell that is used to power a portable electronic device. Battery cell 200 includes a jelly roll 202 containing a number of layers which are wound together, including a cathode with an active coating, a separator, and an anode with an active coating.

More specifically, jelly roll 202 may include one strip of cathode material (e.g., aluminum foil coated with a lithium compound) and one strip of anode material (e.g., copper foil coated with carbon) separated by one strip of separator material (e.g., conducting polymer electrolyte). The cathode, anode, and separator layers may then be wound on a mandrel to form a spirally wound structure. Alternatively, the layers may be used to form other types of battery cell structures, such as bi-cell structures. Jelly rolls are well known in the art and will not be described further.

During assembly of battery cell 200, jelly roll 202 is enclosed in a flexible pouch, which is formed by folding a flexible sheet along a fold line 212. For example, the flexible sheet may be made of aluminum with a polymer film, such as polypropylene and/or polyethylene. After the flexible sheet is folded, the flexible sheet can be sealed, for example by applying heat along a side seal 210 and along a terrace seal 208.

Jelly roll 202 also includes a set of conductive tabs 206 coupled to the cathode and the anode. Conductive tabs 206 may extend through seals in the pouch (for example, formed using sealing tape 204) to provide terminals for battery cell 200. Conductive tabs 206 may then be used to electrically couple battery cell 200 with one or more other battery cells to form a battery pack. For example, the battery pack may be formed by coupling the battery cells in a series, parallel, or series-and-parallel configuration.

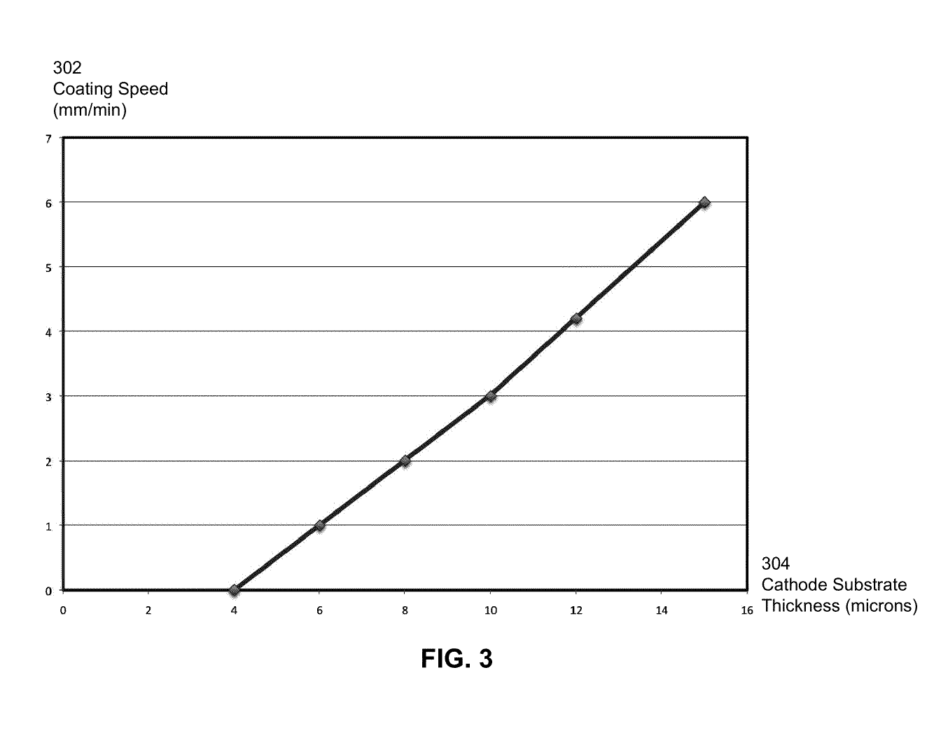

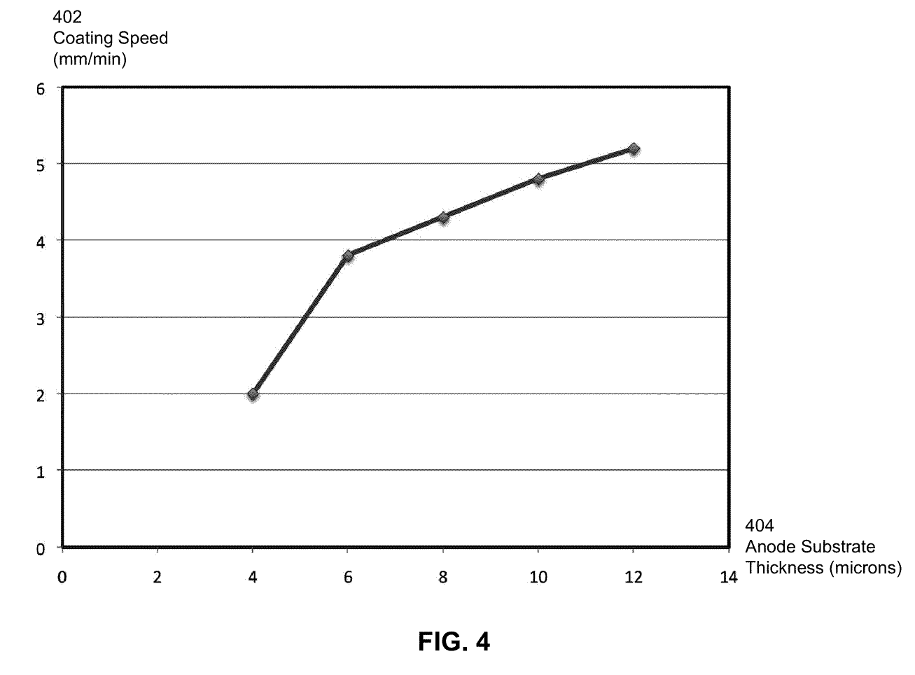

In one or more embodiments, the energy density of battery cell 200 is increased by reducing the thicknesses of the cathode and anode substrates and proportionately increasing the thicknesses of the cathode and anode active materials in jelly roll 202. However, such increased proportions of active material to substrate may result in manufacturing defects such as breaks, crinkles, convolutions, nicks, and/or dents. To mitigate and/or prevent such defects, the cathode and anode substrates may respectively be coated with the cathode and anode active materials at coating speeds that are based on the thicknesses of the cathode and anode substrates, as discussed in further detail below with respect to FIGS. 3-4.

FIG. 3 shows an exemplary plot in accordance with the disclosed embodiments. More specifically, FIG. 3 shows a plot of coating speed 302 of cathode active material on a cathode substrate in mm/min as a function of cathode substrate thickness 304 in microns. As mentioned above, coating speed 302 may vary based on cathode substrate thickness 304 to prevent and/or mitigate manufacturing defects such as breaks, crinkles, convolutions, nicks, and/or dents during the formation of a cathode for a battery cell (e.g., battery cell 200 of FIG. 2) using the cathode active material and cathode substrate.

As shown in FIG. 3, coating speed 302 is substantially linear with respect to cathode substrate thickness 304. In particular, coating speed 302 may be 6 mm/min for cathode substrate thickness 304 of 15 microns, 4.2 mm/min for cathode substrate thickness 304 of 12 microns, 3 mm/min for cathode substrate thickness 304 of 10 microns, and 2 mm/min for cathode substrate thickness 304 of 8 microns. While the plot also shows coating speed 302 for cathode substrate thickness 304 below 8 microns, a drop of coating speed 302 below 2 mm/min may not be practical, cost-effective, and/or reliable enough for use in manufacturing the battery cell.

On the other hand, the use of a 2 mm/min to 3 mm/min coating speed 302 to produce a cathode with cathode substrate thickness 304 in the range of 8-10 microns may avert the manufacturing defects described above while increasing the energy density of the battery cell over that of a conventional battery cell with a thicker cathode substrate. For example, the reduction of cathode substrate thickness 304 from 15 microns to 10 microns and a corresponding increase in cathode active material thickness from 25 microns to 30 microns may provide a 20% increase in capacity and/or energy density in the battery cell. A further reduction of cathode substrate thickness 304 to 8 microns and an increase in cathode active material thickness to 32 microns may provide a 28% increase in capacity and/or energy density over a conventional battery cell with a 15-micron-thick cathode substrate.

FIG. 4 shows an exemplary plot in accordance with the disclosed embodiments. More specifically, FIG. 4 shows a plot of coating speed 402 of anode active material on an anode substrate in mm/min as a function of anode substrate thickness 404 in microns. As with the plot of FIG. 3, coating speed 402 may be based on anode substrate thickness 404 to prevent and/or mitigate manufacturing defects during the formation of an anode for a battery cell (e.g., battery cell 200 of FIG. 2) using the anode active material and anode substrate.

Like coating speed 302 of FIG. 3, coating speed 402 is substantially linear with respect to anode substrate thickness 404 in the range of 6-12 microns. Coating speed 402 may be 5.2 mm/min for anode substrate thickness 404 of 12 microns, 4.8 mm/min for anode substrate thickness 404 of 10 microns, 4.3 mm/min for anode substrate thickness 404 of 8 microns, and 3.8 mm/min for anode substrate thickness 404 of 6 microns. However, coating speed 402 may drop nonlinearly to 2 mm/min as anode substrate thickness 404 drops to 4 microns.

Thus, the use of a 2 mm/min to a 3.8 mm/min coating speed 402 to produce an anode with anode substrate thickness 404 in the range of 4-6 microns may enable the manufacturing of a battery cell with a higher energy density and/or capacity than those of a conventional battery cell. For example, the reduction of anode substrate thickness 404 from 10 microns to 6 microns and a corresponding increase in anode active material thickness from 25 microns to 29 microns may provide a 16% increase in capacity and/or energy density in the battery cell. Similarly, a reduction of anode substrate thickness 404 to 4 microns and an increase in anode active material thickness to 31 microns may provide a 24% increase in capacity and/or energy density over the conventional battery cell.

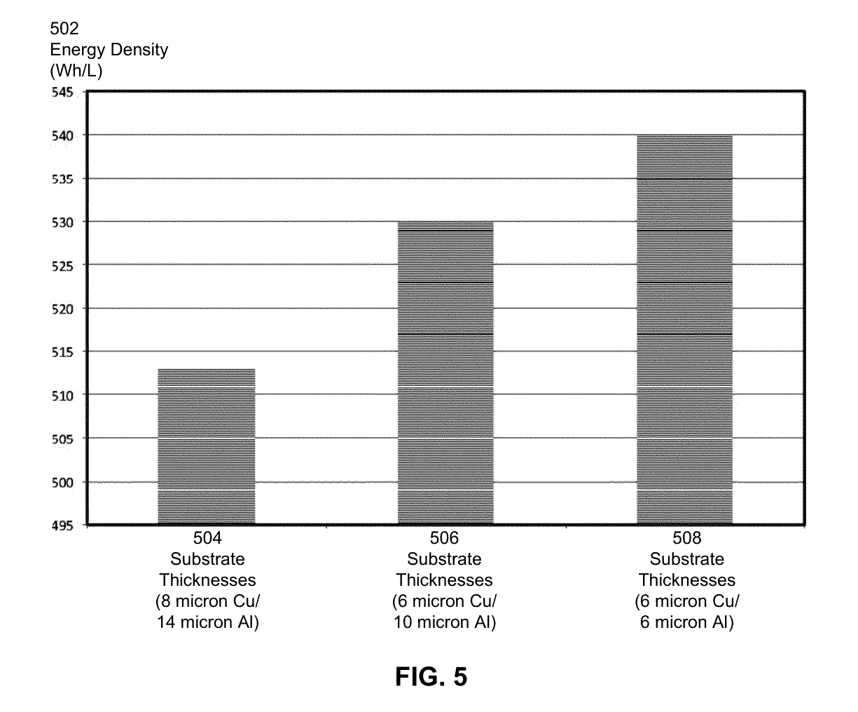

FIG. 5 shows an exemplary plot in accordance with the disclosed embodiments. In particular, FIG. 5 shows bar chart of an energy density 502 of a battery cell in Wh/L for three different sets of substrate thicknesses 504-508. First, energy density 502 may be about 513 Wh/L for a battery cell with substrate thicknesses 504 of 8 microns of copper (e.g., anode substrate) and 14 microns of aluminum (e.g., cathode substrate). Next, energy density 502 may be about 530 Wh/L for a battery cell with substrate for a battery cell with substrate thicknesses 506 of 6 microns of copper (e.g., anode substrate) and 10 microns of aluminum (e.g., cathode substrate). Finally, energy density 502 may be about 540 Wh/L for a battery cell with substrate thicknesses 508 of 6 microns of copper (e.g., anode substrate) and 6 microns of aluminum (e.g., cathode substrate).

Such increases in energy density 502 within the same volume of space in the battery cell may be enabled by increasing the thicknesses of cathode and anode active material in response to decreases in substrate thicknesses 504-508. For example, substrate thicknesses 504-508 may enable cathode active material thicknesses of 113 mm, 115 mm, and 121 mm and anode active material thicknesses of 125 mm, 128 mm, and 132 mm, respectively. In turn, such increases in cathode and anode active material provided by decreases in substrate thicknesses 504-508 may provide capacities of 1530 mAh, 1574 mAh, and 1610 mAh for substrate thicknesses 504-508, respectively. Consequently, substrate thicknesses 506-508 may represent increases of about 3% and 5% in both capacity and energy density over substrate thicknesses 504, respectively, without increasing the volume and/or thickness of the battery cell.

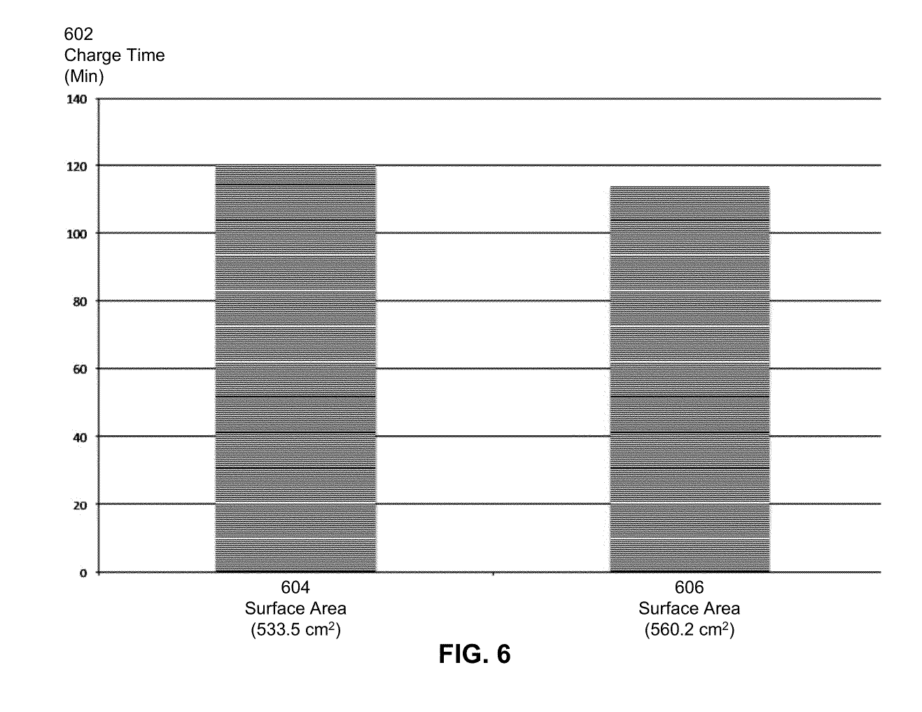

Alternatively, decreases in substrate thicknesses 504-508 may be used to increase the surface area of the battery cell instead of the amount of cathode and anode active material in the battery cell. The increased surface area may further enable an increase in the charge current of the battery cell without reducing the cycle life of the battery cell, as described in further detail below with respect to FIG. 6.

FIG. 6 shows an exemplary plot in accordance with the disclosed embodiments. In particular, FIG. 6 shows a bar chart of a charge time 602 of a battery cell in minutes with two different surface areas 604-606. Charge time 602 of a battery cell with a surface area 604 of 533.5 cm² may be about 120 minutes, while charge time 602 of a battery cell with a surface area 606 of 560.2 cm² may be about 114 minutes.

As mentioned above, surface area 606 of a battery cell may be increased over surface area 604 of a conventional battery cell without increasing the volume and/or thickness of the battery cell by decreasing the thicknesses and increasing the lengths of cathode and anode substrates in the battery cell. For example, a conventional battery cell with surface area 604 may include anode and cathode substrate thicknesses of 8 microns and 14 microns, respectively, while a battery cell with surface area 606 may include anode and cathode substrate thicknesses of 6 microns and 6 microns, respectively. In turn, the 5% increase in surface area 606 over surface area 604 may provide a corresponding 5% increase in charge current and a 5% decrease in charge time 602 without reducing the cycle life of the battery cell.

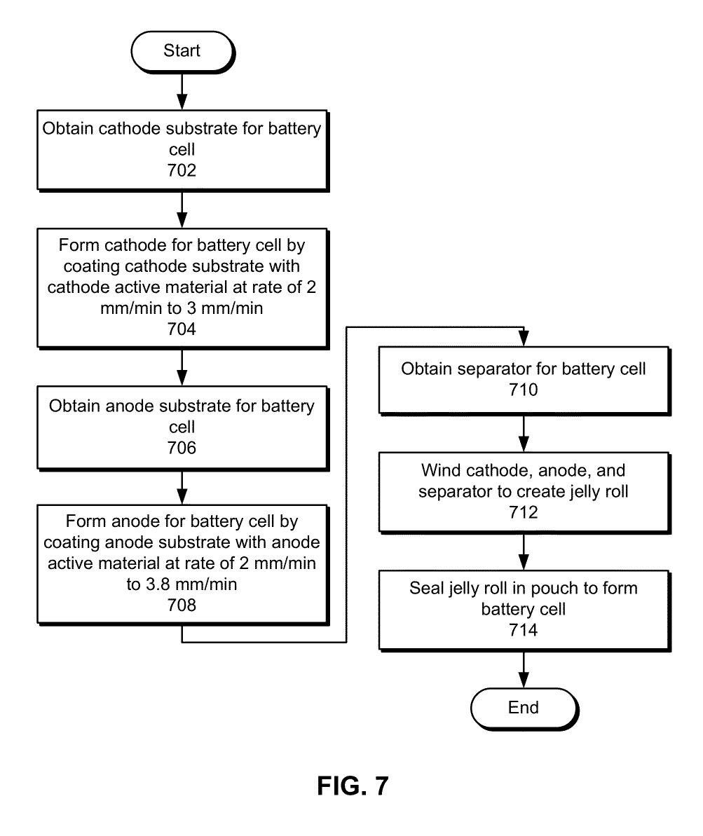

FIG. 7 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the embodiments.

First, a cathode substrate for the battery cell is obtained (operation 702). The cathode substrate may be made of aluminum foil and have a thickness in the range of 8-10 microns. Next, a cathode for the battery cell is formed by coating the cathode substrate with cathode active material at a rate of 2 mm/min to 3 mm/min (operation 704). The thinner cathode substrate and coating speed of the cathode active material may increase the energy density and/or charge current of the battery cell while averting manufacturing defects associated with the use of thinner cathode substrates in battery cells and/or reduced cycle life associated with the use of higher charge currents in battery cells.

An anode substrate for the battery cell is also obtained (operation 706). The anode substrate may be made of copper foil and have a thickness in the range of 4-6 microns. An anode for the battery cell is then formed by coating the anode substrate with anode active material at a rate of 2 mm/min to 3.8 mm/min (operation 708). As with the cathode, the thinner anode substrate and coating speed of the anode active material may increase the energy density and/or charge current of the battery cell without producing manufacturing defects associated with the use of thinner anode substrates in battery cells and/or reducing the cycle life of the battery cell.

After the cathode and anode are formed, a separator for the battery cell is obtained (operation 710), and the cathode, anode, and separator are wound to create a jelly roll (operation 712). The winding step may be skipped and/or altered if the layers are used to create other battery cell structures, such as bi-cells. Finally, the jelly roll is sealed in a pouch to form the battery cell (operation 714). For example, the battery cell may be formed by placing the cathode, anode, and separator layers into the pouch, filling the pouch with electrolyte, and forming side and terrace seals along the edges of the pouch.

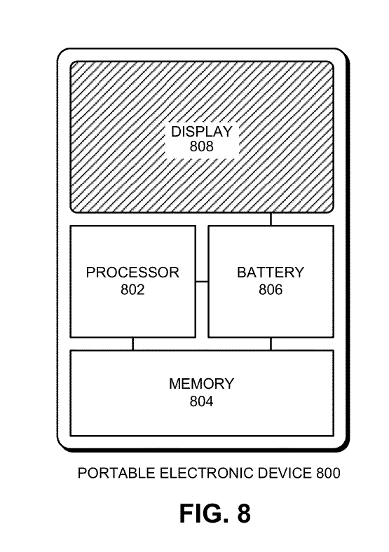

The above-described rechargeable battery cell can generally be used in any type of electronic device. For example, FIG. 8 illustrates a portable electronic device 800 which includes a processor 802, a memory 804 and a display 808, which are all powered by a battery 806. Portable electronic device 800 may correspond to a laptop computer, mobile phone, PDA, tablet computer, portable media player, digital camera, and/or other type of battery-powered electronic device. Battery 806 may correspond to a battery pack that includes one or more battery cells. Each battery cell may include a set of layers sealed in a pouch, including a cathode, a separator, and an anode.

During manufacturing of the battery cell, the cathode is formed by coating a cathode substrate (e.g., aluminum foil) with a thickness in the range of 8-10 microns with a cathode active material at a rate of 2 mm/min to 3 mm/min. Similarly, the anode is formed by coating an anode substrate (e.g., copper foil) with a thickness in the range of 4-6 microns with an anode active material at a rate of 2 mm/min to 3.8 mm/min. The higher proportion of cathode and anode active material to cathode and anode substrate in the battery cell may increase the energy density of the battery cell and/or charge current over that of a conventional battery cell with thicker cathode and anode substrates.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A battery cell, comprising:
a cathode, comprising:
a cathode substrate with a thickness in the range of 8-10 microns; and
a cathode active material, wherein the cathode active material is coated on the cathode substrate at a rate of 2 mm/min to 3 mm/min.

2. The battery cell of claim 1, further comprising:
an anode, comprising:
an anode substrate with a thickness in the range of 4-6 microns; and
an anode active material, wherein the anode active material is coated on the anode substrate at a rate of 2 mm/min to 3.8 mm/min.

3. The battery cell of claim 2, further comprising:
a separator,
wherein the cathode, the anode, and the separator are wound to create a jelly roll.

4. The battery cell of claim 3, further comprising:
a pouch enclosing the jelly roll, wherein the pouch is flexible.

5. The battery cell of claim 2, wherein the anode substrate comprises copper foil.

6. The battery cell of claim 1, wherein the cathode substrate comprises aluminum foil.

7. A portable electronic device, comprising:
a set of components powered by a battery pack; and
the battery pack, comprising:
a battery cell, comprising:
an anode, comprising:
an anode substrate with a thickness in the range of 4-6 microns; and
an anode active material, wherein the anode active material is coated on the anode substrate at a rate of 2 mm/min to 3.8 mm/min.

8. The portable electronic device of claim 7, wherein the battery cell further comprises:
a cathode, comprising:
a cathode substrate with a thickness in the range of 8-10 microns; and
a cathode active material, wherein the cathode active material is coated on the cathode substrate at a rate of 2 mm/min to 3 mm/min.

9. The portable electronic device of claim 8, wherein the battery cell further comprises:
a separator,
wherein the cathode, the anode, and the separator are wound to create a jelly roll.

10. The portable electronic device of claim 9, wherein the battery cell further comprises:
a pouch enclosing the jelly roll, wherein the pouch is flexible.

11. The portable electronic device of claim 8, wherein the cathode substrate comprises aluminum foil.

12. The portable electronic device of claim 7, wherein the anode substrate comprises copper foil.

13. A method for manufacturing a battery cell, comprising:
obtaining a cathode substrate for the battery cell, wherein the cathode substrate has a thickness in the range of 8-10 microns; and
forming a cathode for the battery cell by coating the cathode substrate with cathode active material at a rate of 2 mm/min to 3 mm/min.

14. The method of claim 13, further comprising:
obtaining an anode substrate for the battery cell, wherein the anode substrate has a thickness in the range of 4-6 microns; and
forming an anode for the battery cell by coating the anode substrate with anode active material at a rate of 2 mm/min to 3.8 mm/min.

15. The method of claim 14, further comprising:
obtaining a separator for the battery cell; and
winding the cathode, the anode, and the separator to create a jelly roll.

16. The method of claim 15, further comprising:
sealing the jelly roll in a pouch to form the battery cell, wherein the pouch is flexible.

17. The method of claim 14, wherein the anode substrate comprises copper foil.

18. The method of claim 13, wherein the cathode substrate comprises aluminum foil.

19. A method for manufacturing a battery cell, comprising:
obtaining an anode substrate for the battery cell, wherein the anode substrate has a thickness in the range of 4-6 microns; and
forming an anode for the battery cell by coating the anode substrate with anode active material at a rate of 2 mm/min to 3.8 mm/min.

20. The method of claim 19, further comprising:
obtaining a cathode substrate for the battery cell, wherein the cathode substrate has a thickness in the range of 8-10 microns; and
forming a cathode for the battery cell by coating the cathode substrate with cathode active material at a rate of 2 mm/min to 3 mm/min.

21. The method of claim 20, further comprising:
obtaining a separator for the battery cell; and
winding the cathode, the anode, and the separator to create a jelly roll.

22. The method of claim 21, further comprising:
sealing the jelly roll in a pouch to form the battery cell, wherein the pouch is flexible.

23. The method of claim 20, wherein the cathode substrate comprises aluminum foil.

24. The method of claim 19, wherein the anode substrate comprises copper foil.
